(19) United States
(12) Patent Application Publication
(10) Pub. No.: US 2010/0238841 A1
(43) Pub. Date: Sep. 23, 2010

(54) Method and Device for Holding Calls

(75) Inventors: Shuiping Long, Shenzhen (CN); Hui Jin, Shenzhen (CN)

Correspondence Address: Slater & Matsil, L.L.P., 17950 Preston Road, Suite 1000, Dallas, TX, 75252, US

(73) Assignee: HUAWEI TECHNOLOGIES CO., LTD., Shenzhen (CN)

(21) Appl. No.: 12/793,211

(22) Filed: Jun. 3, 2010

Related U.S. Application Data
(63) Continuation of application No. PCT/CN2008/073331, filed on Dec. 4, 2008.

(30) Foreign Application Priority Data
Dec. 4, 2007 (CN) 200710193853.1

(51) Int. Cl. H04L 12/16

(52) U.S. Cl. 370/259

(57) ABSTRACT

In a method for holding calls, a first UE performs a first call with a second UE through a first CS access call leg. A signaling endpoint of the first CS access call leg is an ICCF and the first CS access call leg supports a first media type. An ICCC request is sent to hold the first call. The first UE sends an ICCC request to initiate a second call with a third UE. The second call is performed with the third UE through a second CS access call leg. The second CS access call leg supports a second media type.

This application is a continuation of co-pending International Application No. PCT/CN2008/073331, filed Dec. 4, 2008, which designated the United States and was not published in English, and which claims priority to Chinese Application No. 200710193853.1 filed Dec. 4, 2007, both of which applications are incorporated herein by reference.

### TECHNICAL FIELD

The present invention relates to the communication field, and in particular, to a method and device for holding calls under an IMS Centralized Service (ICS, where IMS is an acronym of IP Multimedia Subsystem).

### BACKGROUND

If User Equipment (UE) is capable of accessing only a Circuit Switched (CS) domain network, or if a Packet Switched (PS) domain access network that the UE can access does not support real-time voice or video media, the control bit of the ICS of the 3rd Generation Partnership Project (3GPP) enables the UE to bear voice or video media through a CS domain network and set up an IMS call, and an application server in the IMS provides services for the call. In order for the UE to bear voice or video media through a CS domain network, a CS domain call is set up between the UE and the newly introduced IMS CS Control Function (ICCF). That is, the UE performs an IMS call through a CS access call leg. Meanwhile, the service processing logic in a Visited Mobile Switching Center (VMSC) is weakened or removed. Through a newly introduced IMS CS Control Channel (ICCC), the UE receives and sends the control signaling relative to the IMS call. The ICCC may be carried through an Unstructured Supplementary Service Data (USSD, which is a message communication mechanism in a CS domain network) or a PS domain call (namely, another IMS call).

Call holding means that the UE holds a current call and sets up a new call at the same time. In order to implement call holding on a UE, the CS network provides a service feature: Service Change and Unstructured Data Information Fallback (SCUDIF) feature. Unstructured Data Information (UDI) is a bearing capability of the CS network, namely, the UE can send data at a rate of 64 Kbps. A typical application of this bearing capability is video calls. Service change enables the UE to shift between a voice call and a video call in the call process without interrupting the call. Fallback enables the UE to set up a voice call when the UE fails in an attempt of setting up a video call, and ensures successful setup of a conversation.

According to the SCUDIF feature, the ICS Project provides a call hold service solution. The call hold process under the solution is described as follows.

FIG. 1 shows a call hold process. The following describes components in FIG. 1.

The ICS UE-A is an enhanced UE that supports ICCC. At the beginning, UE-A and UE-B perform the first call through a CS access call leg. The signaling endpoint of the CS access call leg is an ICCF, but the media stream endpoint is a Media Gateway Control Function (MGCF). Therefore, the media connection of the first call includes two parts: CS media connection (from UE-A to an MGW, where MGW is an acronym of Media Gateway) and IP media connection (from the MGW to UE-B). The MGW implements conversion between UE-A and UE-B. It is to be noted that an IMS Telephone Application Server (TAS) exists in the signaling path between the ICCF and UE-B, and between the ICCF and UE-C, but is not illustrated in FIG. 1. The TAS performs the operations such as controlling media resource functions, playing a call hold announcement, and collecting charging events. The embodiments of the present invention do not need to enhance the TAS, and therefore, TAS is not mentioned in the following texts or drawings any more.

As shown in FIG. 1, a call hold process in the ICS is as follows:

1. Through the ICCC, UE-A sends a request for holding the current call to the ICCF.

2. The ICCF sends a call hold request to UE-B. The request may be sent through a Session Initiation Protocol (SIP) re-Invite message or an Update message.

3. UE-A sends a request for calling UE-C to the ICCF.

4. The ICCF sends a call request (Invite) to UE-C. The call request carries media information of the IP media connection port of the MGW. The media information is stored in the ICCF in the process of setting up the previous call.

5. UE-C provides an indication, indicating that it is ringing and waiting for an answer from the user.

6. The ICCF sends the media information of UE-C to the MGCF through an Update message. The MGCF instructs the MGW to connect UE-C.

7. UE-C instructs the user to answer the call, and sends a 200 OK to the ICCF.

8. Through an ICCC, the ICCF indicates that the call is answered.

The basic idea of the foregoing solution in the prior art is: The CS media connection is reused, and the IP media connection peer of the MGW may be either UE-B or UE-C. However, it is applicable to the scenario with only two voice calls or two video calls but not applicable to the scenario with two different calls because different calls require different CS media connections.

### SUMMARY OF THE INVENTION

The embodiments of the present invention provide a method and device for holding calls to hold two calls of different media types.

In a method for holding calls, a first UE performs a first call with a second UE through a first CS access call leg. A signaling endpoint of the first CS access call leg is an ICCF and the first CS access call leg supports a first media type. An ICCC request is sent to hold the first call. The first UE sends an ICCC request to initiate a second call with a third UE. The second call is performed with the third UE through a second CS access call leg. The second CS access call leg supports a second media type.

A method for holding calls includes:

holding a first call between a first UE and a second UE according to an ICCC request from the first UE;

receiving a call request from the first UE, wherein a media type in the call request is different from a media type of the first call; and

initiating a second call between the first UE and a third UE according to the call request

A control device for holding calls includes a holding unit adapted to hold a first call between a first UE and a second UE. A receiving unit is adapted to receive a call request from the first UE when the holding unit holds the first call, wherein a media type in the call request is different from a media type of the first call. A controlling unit is adapted to initiate a second call between the first UE and a third UE according to the call request received by the receiving unit.

A UE for holding calls includes a first call performing unit adapted to perform a first call with a second UE through a first CS access call leg. A signaling endpoint of the first CS access call leg is an ICCF and the first CS access call leg supports a first media type. A holding unit is adapted to send an IMS CS Control Channel (ICCC) request to hold the first call. A second call initiating unit is adapted to send an ICCC request to initiate a second call with a third. A second call performing unit is adapted to perform the second call with the third UE through a second CS access call leg that supports a second media type.

Through the method and the device for holding calls in an embodiment of the present invention, when a first call is being performed between the UE and a second UE through a first CS access call leg, the UE performs a second call with a third UE through a second CS access call leg; the media type supported by the first CS access call leg is different from the media type supported by the second CS access call leg. In this way, two calls of different media types can be held.

### BRIEF DESCRIPTION OF THE DRAWINGS

FIG. 1 is a flowchart of holding calls in the prior art;

FIG. 2 is a flowchart of holding calls in the first embodiment of the present invention;

FIG. 3 is a flowchart of holding calls in the second embodiment of the present invention;

FIG. 4 is a flowchart of holding calls in the third embodiment of the present invention;

FIG. 5 is a flowchart of holding calls in the fourth embodiment of the present invention;

FIG. 6 is a flowchart of holding calls in the fifth embodiment of the present invention; and

FIG. 7 is a flowchart of holding calls in the sixth embodiment of the present invention.

### DETAILED DESCRIPTION OF ILLUSTRATIVE EMBODIMENTS

Before elaborating the solution under the present invention, a term is introduced. Service Change and UDI Fallback (SCUDIF) is a CS network service feature, in which, service change enables a UE to shift between a voice call and a video call in a call process without interrupting the call, and fallback enables the UE to set up a voice call after failing in an attempt to setting up a video call and ensures call setup.

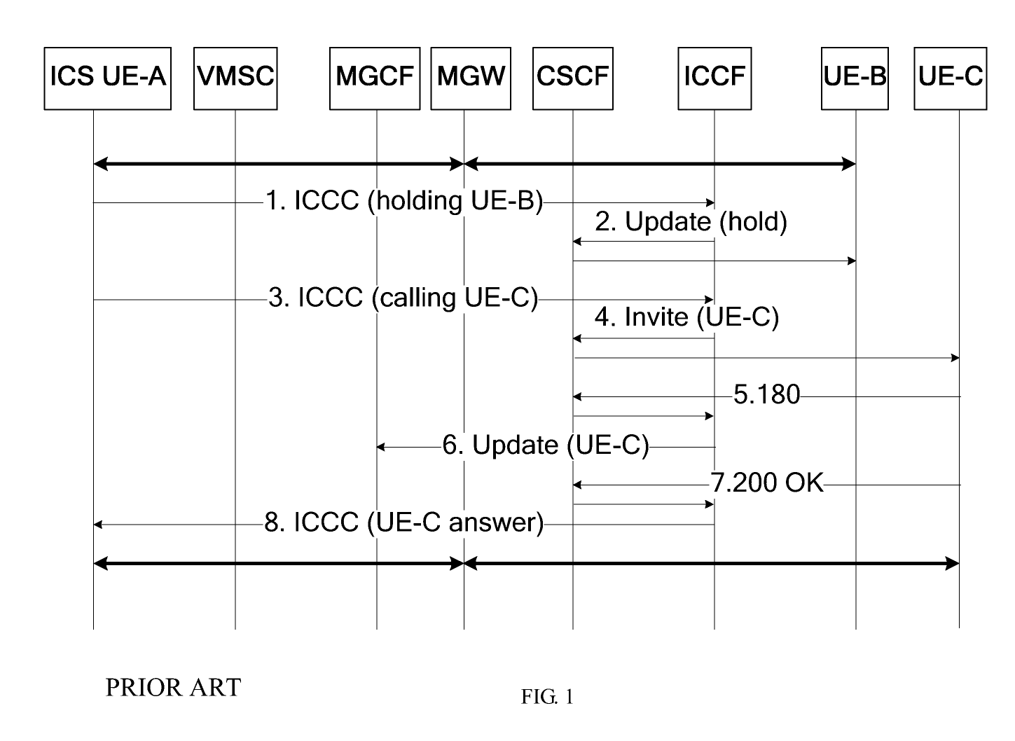

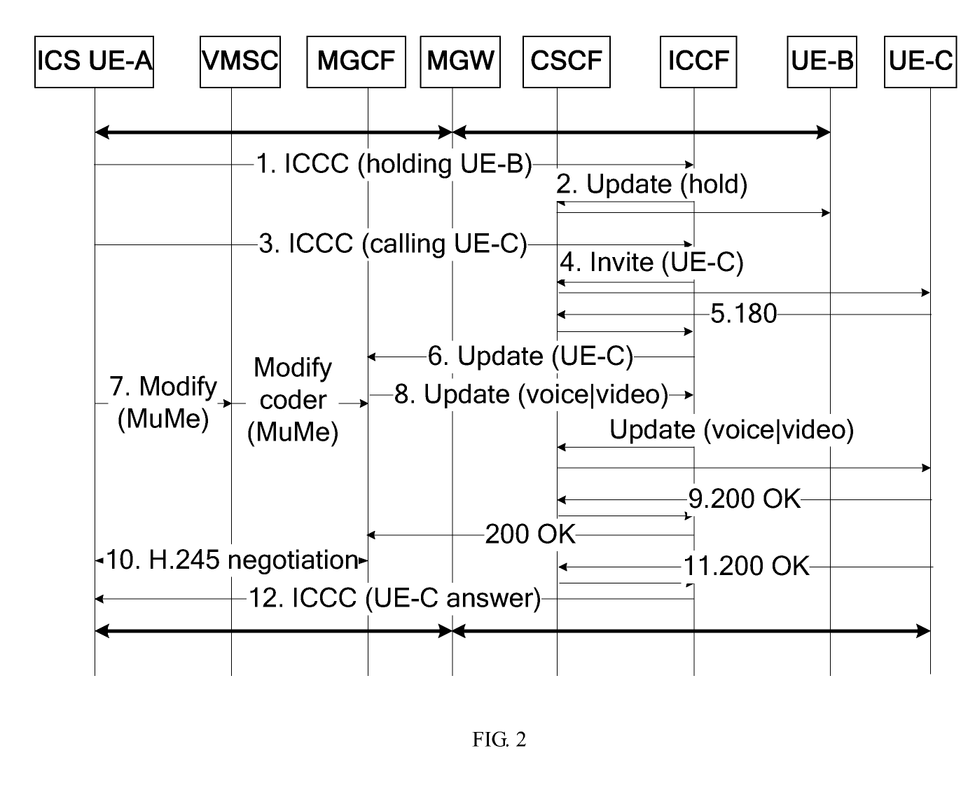

FIG. 2 is a flowchart of holding calls in the first embodiment of the present invention. In this flowchart, a video call is set up when a voice call is underway, and the existing voice call is still held. Compared with the prior art (illustrated in FIG. 1), this flowchart includes new steps, steps 7-11.

UE-A and UE-B perform a voice call through a first CS access call leg. The first CS access call leg is set up between UE-A and an ICCF. The signaling endpoint of the first CS access call leg is the ICCF, but the media stream endpoint is an MGCF. Therefore, the media connection of the voice call includes two parts: CS media connection (from UE-A to an MGW) and IP media connection (from the MGW to UE-B). The first CS access call leg supports the first media type, namely, voice.

1. Through the ICCC, UE-A sends a request for holding the current call to the ICCF.

2. The ICCF sends a call hold request to UE-B. The request may be sent through a SIP re-Invite message or an Update message.

3. UE-A sends a request for calling UE-C to the ICCF.

4. The ICCF sends a call request (Invite) to UE-C. The call request carries media information of the IP media connection port of the MGW. The media information is stored in the ICCF in the process of setting up the previous call.

5. UE-C provides an indication, indicating that it is ringing and waiting for an answer from the user.

6. The ICCF sends the media information of UE-C to the MGCF through an Update message. The MGCF instructs the MGW to connect UE-C.

7. UE-A sends a request for changing a CS call mode to a VMSC network, requesting changing the CS voice call to a CS multimedia call. Through a message between core networks, the VMSC sends a request for changing the CS call mode to the MGCF.

8. The MGCF generates a SIP media negotiation message to the ICCF, requesting adding video media type to be supported. Through a CSCF, the ICCF sends a media negotiation message to UE-C.

9. UE-C accepts the request for adding the media type, and returns a 200 OK response. The ICCF forwards the response.

10. The MGCF and UE-A perform inband H.245 negotiation (inband interaction refers to interaction performed through a data channel rather than a signaling path, and therefore, the MGCF needs to perform the negotiation by interacting through an MGW).

11. UE-C instructs the ICCF that the user has answered the call by sending a 200 OK to the ICCF.

12. Through an ICCC, the ICCF indicates that the call is answered.

UE-A performs the second call with UE-C through a second CS access call leg that supports a second media type. The second CS access call leg is set up between UE-A and an ICCF. The signaling endpoint of the second CS access call leg is the ICCF, but the media stream endpoint is an MGW. Therefore, the media connection of the voice call includes two parts: CS media connection (from UE-A to the MGW) and IP media connection (from the MGW to UE-C). The second CS access call leg supports the second media type, namely, multimedia.

Steps 7-10 are a process of using UE-A to initiate change of the CS media connection. In this solution, the ICCF does not need to be modified on the basis of the protocol, but UE-A needs to be enhanced on the basis of the protocol. The enhancement is as follows: A call hold application determines that the new call is of a different media type, and can initiate change of the CS media connection, namely, change the voice media connection to a media connection that supports both voice and video. UE-A uses an SCUDIF feature.

Alternatively, the ICCF initiates the CS media connection change, namely, change the voice media connection to a media connection that supports both voice and video. The ICCF needs to be enhanced on the basis of the protocol. The enhancement is as follows: A call hold application determines that the new call is of a different media type, and can initiate change of the CS media connection, namely, change the voice media connection to a media connection that supports both voice and video.

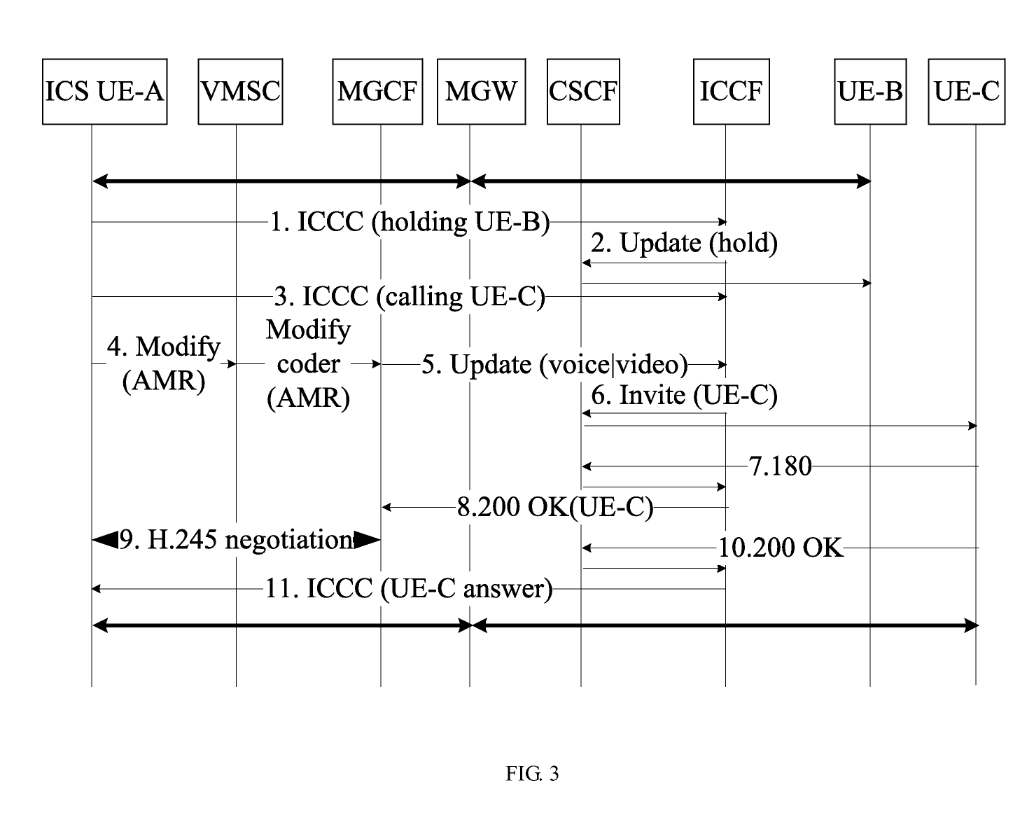

FIG. 3 is a flowchart of holding calls in the second embodiment of the present invention. In this flowchart, a video call is set up when a voice call is underway, and the existing voice call is still held. This embodiment differs from the first embodiment in that: In step 3, after the ICCF receives the call request of a new media type of UE-A, the ICCF waits for a media negotiation request (that carries the new media information of the MGW) from the MGCF. After receiving the media negotiation request, the ICCF sends a call request to UE-C.

1. Through the ICCC, UE-A sends a request for holding the current call to the ICCF.

2. The ICCF sends a call hold request to UE-B. The request may be sent through a SIP re-Invite message or an Update message.

3. UE-A sends a request for calling UE-C to the ICCF, indicating that the call is of a new media type.

4. UE-A sends a request for changing a CS call mode to a VMSC network, requesting changing the CS voice call to a CS multimedia call. Through a message between core networks, the VMSC sends a request for changing the CS call mode to the MGCF.

5. The MGCF generates a SIP media negotiation message to the ICCF, requesting adding video media type to be supported.

6. The ICCF sends a call request (Invite) to UE-C. The call request carries the new media information of the MGW.

7. UE-C provides an indication, indicating that it is ringing and waiting for an answer from the user.

8. The ICCF indicates to the MGCF that the request for adding the media type is accepted.

9. The MGCF and UE-A perform inband H.245 negotiation (inband interaction refers to interaction performed through a data channel rather than a signaling path, and therefore, the MGCF needs to perform the negotiation by interacting through an MGW).

10. UE-C instructs the ICCF that the user has answered the call by sending a 200 OK to the ICCF.

11. Through an ICCC, the ICCF indicates that the call is answered.

In the foregoing solution, the ICCF needs to be modified. After a call request of the new media type (indicated in the message sent in step 3) is received from UE-A, the ICCF waits for a media negotiation request (that carries the new media information of the MGW) from the MGCF. After receiving the media negotiation request, the ICCF sends a call request to UE-C. UE-A requires enhancement. That is, a call hold application determines that the new call is of a different media type, and can initiate change of the CS media connection, namely, change the voice media connection to a media connection that supports both voice and video. UE-A uses an SCUDIF feature. Same as in the first embodiment, the change of the CS media connection may be initiated by the ICCF.

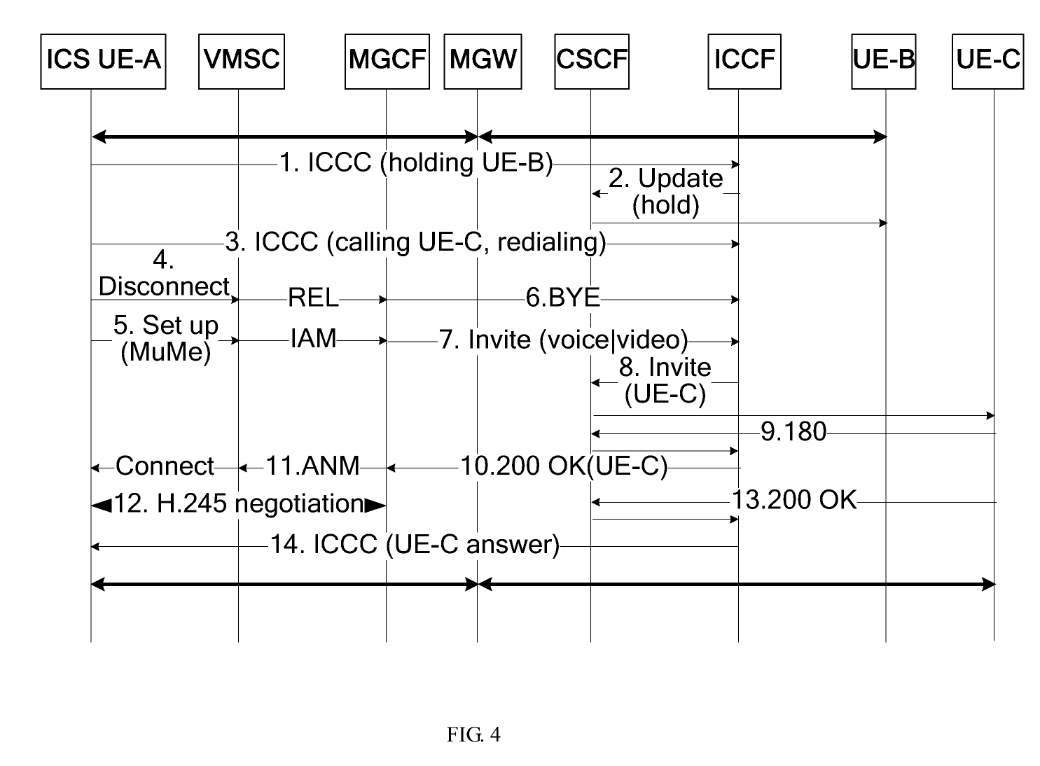

FIG. 4 is a flowchart of holding calls in the third embodiment of the present invention. In this flowchart, a video call is set up when a voice call is underway, and the existing voice call is still held. This embodiment differs from the second embodiment in that: The first CS access call leg is released first, and then the second CS access call leg is set up.

1. Through the ICCC, UE-A sends a request for holding the current call to the ICCF.

2. The ICCF sends a call hold request to UE-B. The request may be sent through a SIP re-Invite message or an Update message.

3. UE-A sends a request for calling UE-C to the ICCF.

4. UE-A requests the VMSC to release the current call, and the VMSC sends a release request to the MGCF.

5. The MGCF generates a SIP session release request to the ICCF.

6. The UE-A sends a request for initiating a multimedia call (voice and video) to the VMSC, and the VMSC sends a call request to the MGCF.

7. The MGCF generates a SIP multimedia session invitation and sends it to the ICCF.

8. The ICCF sends a call request (Invite) to UE-C. The call request carries the new media information of the MGW.

9. UE-C provides an indication, indicating that it is ringing and waiting for an answer from the user.

10. The ICCF indicates to the MGCF that the session invitation is accepted.

11. The MGCF indicates to the VMSC that the call request is accepted, and the VMSC indicates to the UE-A that the call is accepted.

12. The MGCF and UE-A perform inband H.245 negotiation (inband interaction refers to interaction performed through a data channel rather than a signaling path, and therefore, the MGCF needs to perform the negotiation by interacting through an MGW).

13. UE-C instructs the ICCF that the user has answered the call by sending a 200 OK to the ICCF.

14. Through an ICCC, the ICCF indicates that the call is answered.

This embodiment differs from the second embodiment in that UE-A needs to be enhanced in these aspects: A call hold application determines that the new call is of a different media type and can initiate release of the first CS access call leg, and UE-A uses an SCUDIF feature. Alternatively, the ICCF initiates release of the first CS access call leg.

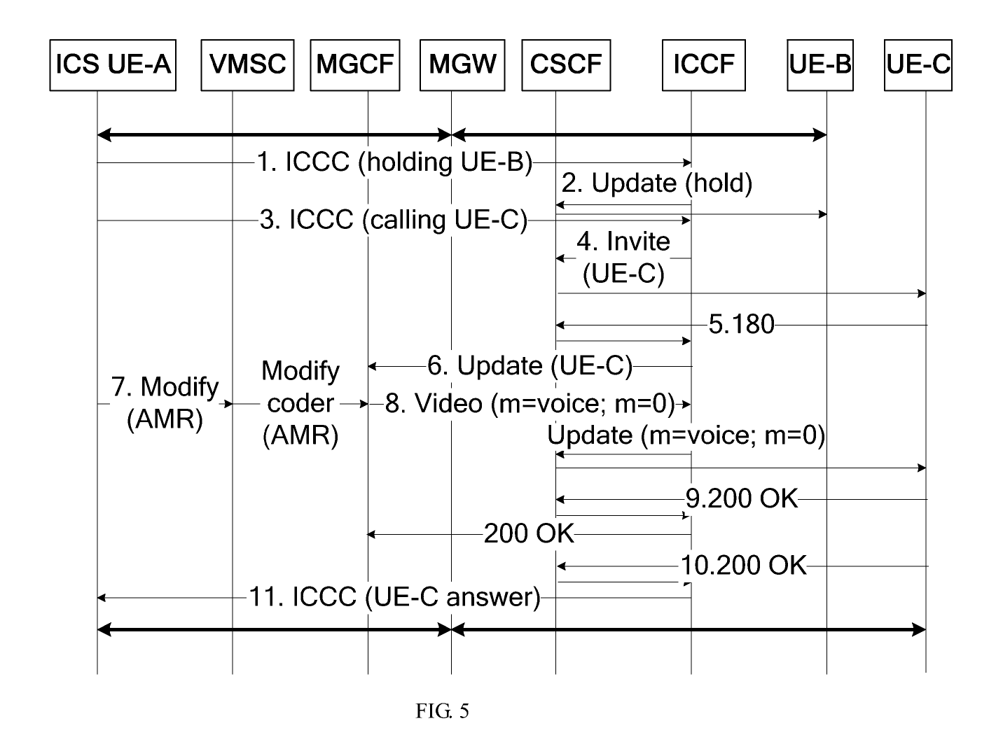

FIG. 5 is a flowchart of holding calls in the fourth embodiment of the present invention. This embodiment differs from the first embodiment in that: The holding of an existing video call at the time of initiating a voice call involves no H.245 negotiation process.

1. Through the ICCC, UE-A sends a request for holding the current call to the ICCF.

2. The ICCF sends a call hold request to UE-B. The request may be sent through a SIP re-Invite message or an Update message.

3. UE-A sends a request for calling UE-C to the ICCF.

4. The ICCF sends a call request (Invite) to UE-C. The call request carries media information of the IP media connection port of the MGW. The media information is stored in the ICCF in the process of setting up the previous call.

5. UE-C provides an indication, indicating that it is ringing and waiting for an answer from the user.

6. The ICCF sends the media information of UE-C to the MGCF through an Update message. The MGCF instructs the MGW to connect UE-C.

7. UE-A sends a request for changing a CS call mode to a VMSC network, requesting changing the CS voice call to a CS multimedia call. Through a message between core networks, the VMSC sends a request for changing the CS call mode to the MGCF.

8. The MGCF generates a SIP media negotiation message to the ICCF, requesting adding video media type to be supported. Through a CSCF, the ICCF sends a media negotiation message to UE-C.

9. UE-C accepts the request for adding the video media type, and returns a 200 OK response. The ICCF forwards the response.

10. UE-C instructs the ICCF that the user has answered the call by sending a 200 OK to the ICCF.

11. Through an ICCC, the ICCF indicates that the call is answered.

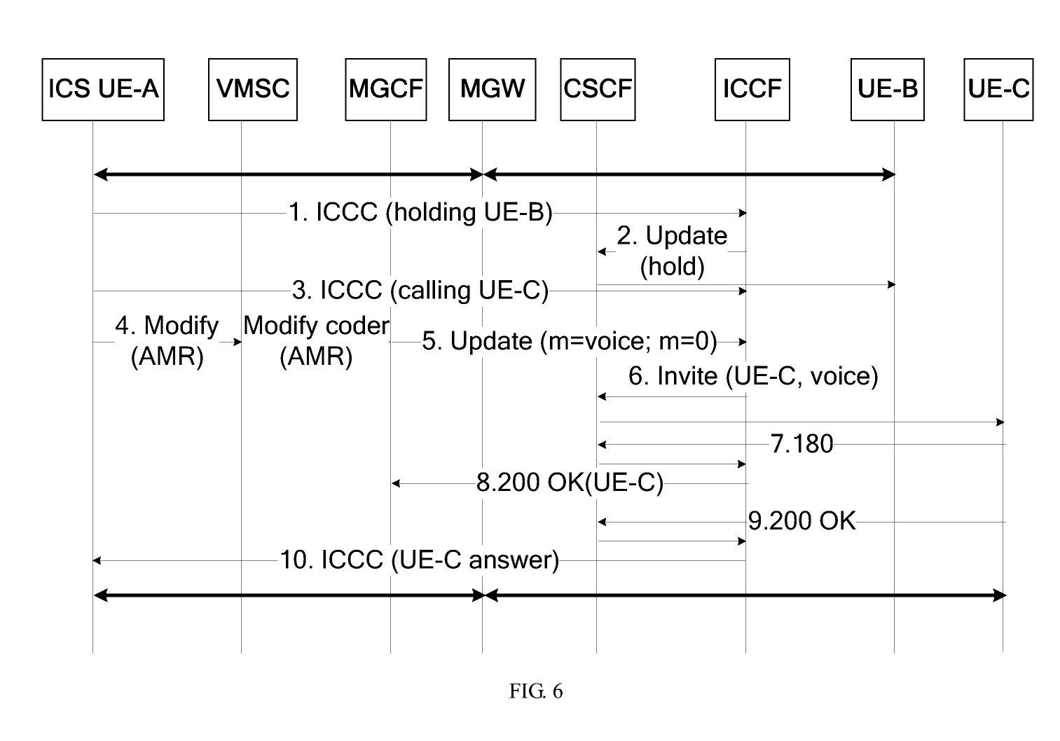

FIG. 6 is a flowchart of holding calls in the fifth embodiment of the present invention. This embodiment differs from the second embodiment in that: The holding of an existing video call at the time of initiating a voice call involves no H.245 negotiation process.

1. Through the ICCC, UE-A sends a request for holding the current call to the ICCF.

2. The ICCF sends a call hold request to UE-B. The request may be sent through a SIP re-Invite message or an Update message.

3. UE-A sends a request for calling UE-C to the ICCF, indicating that the call is of a new media type.

4. UE-A sends a request for changing a CS call mode to a VMSC network, requesting changing the CS voice call to a CS multimedia call. Through a message between core networks, the VMSC sends a request for changing the CS call mode to the MGCF.

5. The MGCF generates a SIP media negotiation message to the ICCF, requesting adding video media type to be supported.

6. The ICCF sends a call request (Invite) to UE-C. The call request carries the new media information of the MGW.

7. UE-C provides an indication, indicating that it is ringing and waiting for an answer from the user.

8. The ICCF indicates to the MGCF that the request for adding video media type is accepted.

9. UE-C instructs the ICCF that the user has answered the call by sending a 200 OK to the ICCF.

10. Through an ICCC, the ICCF indicates that the call is answered.

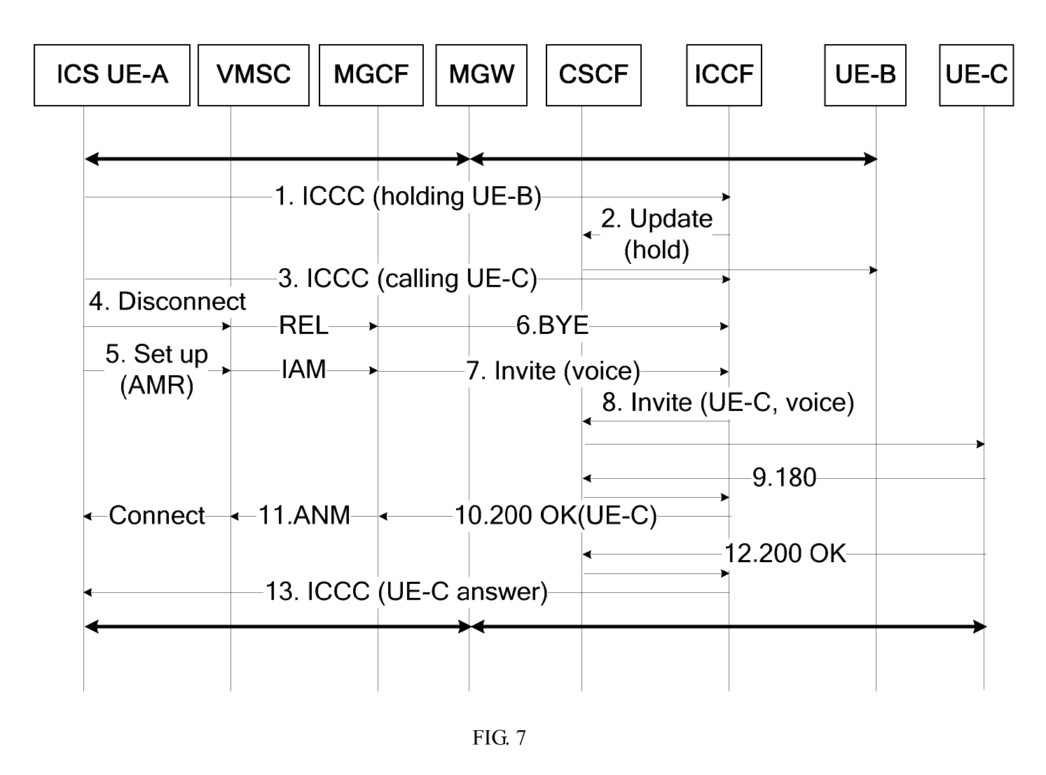

FIG. 7 is a flowchart of holding calls in the sixth embodiment of the present invention. This embodiment differs from the third embodiment in that: The holding of an existing video call at the time of setting up a voice call involves no H.245 negotiation process.

1. Through the ICCC, UE-A sends a request for holding the current call to the ICCF.

2. The ICCF sends a call hold request to UE-B. The request may be sent through a SIP re-Invite message or an Update message.

3. UE-A sends a request for calling UE-C to the ICCF.

4. UE-A requests the VMSC to release the current call, and the VMSC sends a release request to the MGCF.

5. The MGCF generates a SIP session release request to the ICCF.

6. The UE-A sends a request for initiating a multimedia call (voice and video) to the VMSC, and the VMSC sends a call request to the MGCF.

7. The MGCF generates a SIP multimedia session invitation and sends it to the ICCF.

8. The ICCF sends a call request (Invite) to UE-C. The call request carries the new media information of the MGW.

9. UE-C provides an indication, indicating that it is ringing and waiting for an answer from the user.

10. The ICCF indicates to the MGCF that the session invitation is accepted.

11. The MGCF indicates to the VMSC that the call request is accepted, and the VMSC indicates to the UE-A that the call is accepted.

12. UE-C instructs the ICCF that the user has answered the call by sending a 200 OK to the ICCF.

13. Through an ICCC, the ICCF indicates that the call is answered.

A control device for holding calls is provided in an embodiment of the present invention. The control device may be independent, or integrated in a network control device such as ICCF. The control device includes a holding unit adapted to hold a first call between a first UE and a second UE. A receiving unit is adapted to receive a call request from the first UE when the holding unit holds the first call, where a media type in the call request is different from a media type of the first call. A controlling unit is adapted to initiate a second call between the first UE and a third UE according to a call request received by the receiving unit, whereupon the second call goes on between the first UE and the third UE.

The controlling unit may include a call mode changing unit, adapted to: change the CS call mode according to the media type in the call request to obtain a second CS access call leg, and initiate the second call.

The first UE performs the first call with the second UE through a first CS access call leg that supports a first media type. In this case, the controlling unit may include a releasing unit adapted to release the first CS access call leg between the ICCF and the first UE and an initiating unit adapted to initiate a second CS access call leg with the first UE so as to initiate the second call, where the second CS access call leg supports a second media type.

A control device for holding calls is provided in an embodiment of the present invention. The control device may be independent, or integrated in a network control device such as ICCF. The control device includes a receiving unit adapted to receive a media negotiation request from an MGCF after the first UE initiates change of the CS call mode. The media negotiation request carries new media information of the MGW. A sending unit is adapted to send a call request to a third UE after the receiving unit receives the media negotiation request.

Another control device for holding calls is provided in an embodiment of the present invention. The control device may be independent, or integrated in a network control device such as ICCF. The control device includes a receiving unit adapted to receive a media negotiation request from an MGCF after the first UE initiates change of the CS call mode, where the media negotiation request carries new media information of the MGW. A sending unit is adapted to send a call request to a third UE after the receiving unit receives the media negotiation request.

Another control device for holding calls is provided in an embodiment of the present invention. The control device may be independent, or integrated in a network control device such as ICCF. A holding unit is adapted to hold a first call between a first UE and a second UE. A receiving unit is adapted to receive a call request from the first UE when the holding unit holds the first call, where a media type in the call request is different from a media type of the first call. A controlling unit is adapted to initiate CS call mode change after the receiving unit receives a call request.

Another control device for holding calls is provided in an embodiment of the present invention. The control device may be independent, or integrated in a network control device such as an ICCF. A holding unit is adapted to hold a first call between a first UE and a second UE, where the first UE performs the first call with the second UE through a first CS access call leg, and the first CS access call leg supports a first media type. A receiving unit is adapted to receive a call request from the first UE when the holding unit holds the first call, where the media type in the call request is a second media type. A controlling unit is adapted to release the first CS access call leg after the receiving unit receives the call request, and initiate a second CS access call leg with the first UE. The second CS access call leg supports the second media type.

A UE for holding calls is provided in an embodiment of the present invention. The UE includes a first call performing unit adapted to perform a first call with a second UE through a first CS access call leg. A signaling endpoint of the first CS access call leg is an ICCF and the first CS access call leg supports a first media type. A holding unit is adapted to hold the first call according to an ICCC request. A second call initiating unit is adapted to initiate a second call with a third UE according to the ICCC request. A second call performing unit is adapted to perform the second call with the third UE through a second CS access call leg that supports a second media type.

The second call initiating unit may include a call unit adapted to initiate a call request for calling a third UE according to the ICCC request. A changing unit is adapted to change the CS call mode so as to obtain the second CS access call leg and initiate the second call.

The second call initiating unit may include a call unit adapted to initiate a call request for calling a third UE according to the ICCC request and a releasing unit adapted to release the first CS access call leg. An initiating unit is adapted to initiate a second CS access call leg with the ICCF, where the second CS access call leg supports the second media type.

Another UE for holding calls is provided in an embodiment of the present invention. The UE includes a holding unit adapted to send a first call hold request to an ICCF. The first call hold request is designed to hold a first call between the UE and a second UE. The UE performs the first call with the second UE through a first CS access call leg. The first CS access call leg supports a first media type. A calling unit is adapted to send a call request to the ICCF after the holding unit sends the first call hold request, where the media type in the call request is a second media type. A controlling unit is adapted to initiate CS call mode change after the calling unit sends the call request.

Another UE for holding calls is provided in an embodiment of the present invention. The UE includes a holding unit adapted to send a first call hold request to an ICCF. The first call hold request is designed to hold a first call between the UE and a second UE. The UE performs the first call with the second UE through a first CS access call leg. The first CS access call leg supports a first media type. A calling unit is adapted to send a call request to the ICCF after the holding unit sends the first call hold request. The media type in the call request is a second media type. A controlling unit is adapted to release the first CS access call leg after the calling unit sends the call request and initiate a second CS access call leg with the ICCF. The second CS access call leg supports the second media type.

After reading the foregoing embodiments, those skilled in the art are clearly aware that the embodiments of the present invention may be implemented through hardware, or through software in addition to a necessary universal hardware platform, but the latter is preferred in most circumstances. Therefore, the contributions made by the technical solution under the present invention as against the prior art may be partially or completely embodied as a software product. The software product may be stored in a storage medium such as ROM/RAM, magnetic disk, or CD-ROM, and incorporates several instructions for instructing a computer device (for example, personal computer, server, or network device) to execute the method specified in each embodiment of the present invention or a part of the embodiment.

Although the invention is described through some exemplary embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the following claims or their equivalents.

What is claimed is:

1. A call holding method, comprising:
performing, by a first User Equipment (UE), a first call with a second UE through a first Circuit Switched (CS) access call leg, wherein a signaling endpoint of the first CS access call leg is an IP Multimedia Subsystem (IMS) CS Control Function (ICCF), and the first CS access call leg supports a first media type;
sending an IMS CS Control Channel (ICCC) request to hold the first call;
sending an ICCC request from the first UE to initiate a second call with a third UE; and
performing the second call with the third UE through a second CS access call leg, wherein the second CS access call leg supports a second media type.

2. The method of claim 1, wherein sending the ICCC request comprises:
sending a call request for calling the third UE to the ICCF via the ICCC; and
changing the first media type supported by the first CS access call leg to the second media type and obtaining the second CS access call leg, after the ICCF sends the call request to the third UE and controls the first CS access call leg to set up a media connection with the third UE.

3. The method of claim 1, wherein sending the ICCC request comprises:
sending a call request for calling the third UE to the ICCF via the ICCC, wherein the ICCF is adapted to send the call request to the third UE to control the first CS access call leg to set up a media connection with the third UE first, and change the first media type supported by the first CS access call leg to the second media type to obtain the second CS access call leg.

4. The method of claim 1, wherein sending the ICCC request comprises:
sending a call request for calling the third UE to the ICCF via the ICCC; and
initiating release of the first CS access call leg and initiating the second CS access call leg with the ICCF after the ICCF sends the call request to the third UE, wherein the ICCF is adapted to control the second CS access call leg to set up a media connection with the third UE after the first UE sets up the second CS access call leg.

5. The method of claim 1, wherein sending the ICCC request comprises:
sending a call request for calling the third UE to the ICCF via the ICCC, wherein the ICCF is adapted to send the call request to the third UE first, initiate release of the first CS access call leg and initiate the second CS access call leg, and control the second CS access call leg to set up a media connection with the third UE.

6. The method of claim 1, wherein sending the ICCC request comprises:
sending a call request for calling the third UE to the ICCF via the ICCC; and
changing the first media type supported by the first CS access call leg to the second media type, and obtaining the second CS access call leg, wherein the ICCF is adapted to send the call request to the third UE, and control the second CS access call leg to set up a media connection with the third UE after the first UE changes the first media type supported by the first CS access call leg to the second media type.

7. The method of claim 1, wherein sending the ICCC request comprises:
sending a call request for calling the third UE to the ICCF via the ICCC, wherein the ICCF is adapted to change the media type supported by the first CS access call leg to the second media type and obtain the second CS access call leg, and send the call request to the third UE and control the second CS access call leg to set up a media connection with the third UE.

8. The method of claim 1, wherein sending the ICCC request comprises:
sending a call request for calling the third UE to the ICCF via the ICCC; and
by the first UE, initiating release of the first CS access call leg, and initiating the second CS access call leg with the ICCF, wherein the ICCF is adapted to send the call request to the third UE after the first UE initiates the second CS access call leg, and control the second CS access call leg to set up a media connection with the third UE.

9. The method of claim 1, wherein sending the ICCC request comprises:
sending a call request for calling the third UE to the ICCF via the ICCC, wherein the ICCF is adapted to initiate release of the first CS access call leg and initiate the second CS access call leg first, send the call request to the third UE, and control the second CS access call leg to set up a media connection with the third UE.

10. The method of claim 1, wherein the first media type is either voice or multimedia, and the second media type is the other of the voice or multimedia.

11. The method of claim 1, wherein the second CS access call leg is set up by one of the process of:
changing a CS call mode to obtain the second CS access call leg; and
releasing the first CS access call leg, and setting up the second CS access call leg.

12. A call holding method, comprising:
holding a first call between a first User Equipment (UE) and a second UE according to an IP Multimedia Subsystem (IMS) Circuit-switched Control Channel (ICCC) request from the first UE;
receiving a call request from the first UE, wherein a media type in the call request is different from a media type of the first call; and
initiating a second call between the first UE and a third UE according to the call request.

13. The method of claim 12, wherein initiating the second call comprises changing a Circuit Switched (CS) call mode according to the media type of the call request to obtain a second CS access call leg, and initiating the second call based on the second call leg.

14. The method of claim 12, wherein:
the first UE performs the first call with the second UE through a first Circuit Switched (CS) access call leg that supports a first media type; and
initiating the second call comprises releasing the first CS access call leg and initiating a second CS access call leg with the first UE to set up the second call, wherein the second CS access call leg supports a second media type.

15. A control device for holding calls, the control device comprising:
a holding unit adapted to hold a first call between a first User Equipment (UE) and a second UE;
a receiving unit adapted to receive a call request from the first UE when the holding unit holds the first call, wherein a media type in the call request is different from a media type of the first call; and
a controlling unit adapted to initiate a second call between the first UE and a third UE according to the call request received by the receiving unit.

16. The control device of claim 15, wherein the controlling unit comprises a call mode changing unit adapted to change a Circuit Switched (CS) call mode according to the media type in the call request to obtain a second CS access call leg, and to set up the second call by using the second CS access call leg.

17. The control device of claim 15, wherein:
the first UE performs the first call with the second UE through a first Circuit Switched (CS) access call leg that supports a first media type;
the controlling unit comprises:
a releasing unit adapted to release the first CS access call leg; and
an initiating unit adapted to initiate a second CS access call leg with the first UE so as to initiate the second call, wherein the second CS access call leg supports a second media type.

18. A User Equipment (UE) for holding calls, the UE comprising:
a first call performing unit adapted to perform a first call with a second UE through a first Circuit Switched (CS) access call leg, wherein a signaling endpoint of the first CS access call leg is an IP Multimedia Subsystem (IMS) CS Control Function (ICCF) and the first CS access call leg supports a first media type;
a holding unit adapted to send an IMS CS Control Channel (ICCC) request to hold the first call;
a second call initiating unit adapted to send an ICCC request to initiate a second call with a third; and
a second call performing unit adapted to perform the second call with the third UE through a second CS access call leg that supports a second media type.

19. The UE of claim 18, wherein the second call initiating unit comprises:
a call unit adapted to initiate a call request for calling the third UE via the ICCC; and
a changing unit adapted to change a CS call mode so as to obtain the second CS access call leg and initiate the second call.

20. The UE of claim 18, wherein the second call initiating unit comprises:
a call unit adapted to initiate a call request for calling the third UE via the ICCC;
a releasing unit adapted to release the first CS access call leg between the UE and the ICCF; and
an initiating unit adapted to initiate the second CS access call leg with the ICCF, wherein the second CS access call leg supports the second media type.
